(19) United States
(12) Patent Application Publication
(10) Pub. No.: US 2022/0160168 A1
(43) Pub. Date: May 26, 2022

(54) COOKING VESSEL DEVICE

(71) Applicant: BSH Hausgeräte GmbH, Munich (DE)

(72) Inventors: Victor Camañes Vera, Zaragoza (ES); Jorge Mir Bel, Zaragoza (ES); Maria Parra Borderías, Zaragoza (ES); David Valeau Martin, Zaragoza (ES)

(21) Appl. No.: 17/437,064

(22) PCT Filed: May 14, 2020
(86) PCT No.: PCT/EP2020/063446

§ 371 Date: Sep. 8, 2021

(30) Foreign Application Priority Data
May 20, 2019 (EP) 19382401.8

(51) Int. Cl. A47J 36/16; A47J 36/12

(52) U.S. Cl. CPC A47J 36/165; A47J 36/12

(57) ABSTRACT

A cooking vessel device for a cooking vessel includes a stiffing unit including a stiffing element and a retaining element, which retains the stiffing element in an operating state. A drive unit moves the retaining element along a movement path in the operating state.

The invention relates to a cooking vessel device as claimed in claim 1.

A cooking vessel device having a stirring unit with a stirring element and with a retaining element is already known from the European patent application EP 3 298 860 A1. The retaining element retains the stirring element in an operating state. The cooking vessel device has a drive unit, which drives the retaining element in the operating state. In the operating state the stirring element is arranged within a food receiving chamber of a cooking vessel that comprises the cooking vessel device. The drive unit is integrated within a cooking vessel housing unit of the cooking vessel. The retaining element engages through the cooking vessel housing unit and transmits a drive torque from the drive unit to the stirring element. In the operating state, in which the drive unit drives the retaining element, the retaining element is arranged in a stationary manner and remains in its original position.

It is the object of the invention in particular to provide a generic device with improved properties in terms of construction. According to the invention the object is achieved by the features of claim 1, while advantageous embodiments and developments of the invention will emerge from the subclaims.

A cooking vessel device for at least one cooking vessel is proposed, having at least one stirring unit comprising at least one stirring element, which is provided in particular to stir and/or mix at least one medium in at least one operating state, and at least one retaining element, which retains the stirring element in at least one operating state, and having at least one drive unit, which moves the retaining element along an, in particular closed, movement path in the operating state.

Such an embodiment results in a particularly advantageous construction. Movement of the retaining element, and therefore in particular of the stirring element, on the movement path in particular allows an optimal stirring process, during which food present in particular in the cooking vessel can be stirred optimally. A large area in particular can be covered, thereby allowing optimal stirring.

The stirring unit in particular advantageously prevents food burning and/or boiling over and/or allows an optimal food consistency to be achieved, in particular for critical foods such as sauces and/or creams and/or risottos. In particular an operator can undertake at least one further activity, in particular while the stirring unit is stirring, as the constant presence of the operator can be dispensed with and/or is not required, in particular for manual stirring.

A “cooking vessel device” refers in particular to at least a part, in particular a sub-assembly, of the cooking vessel and/or at least one accessory for the cooking vessel. For example the cooking vessel could comprise the cooking vessel device, in particular in the event that the cooking vessel device is part of the cooking vessel. Alternatively or additionally the cooking vessel device could be configured in particular as an accessory for the cooking vessel and be provided in particular for use with the cooking vessel.

The expression cooking vessel device “for” at least one cooking vessel means in particular that the cooking vessel device is provided specifically for the cooking vessel and/or the cooking vessel device is tailored specifically to the cooking vessel.

A “cooking vessel” refers in particular to a unit, which in particular at least partially defines and/or delimits at least one food receiving chamber and which is provided in particular for heating, in particular by means of at least one heating unit, in particular of at least one cooking system and/or at least one cooking appliance, and which is provided in particular to heat and/or cook and/or keep warm at least one food arranged in the food receiving chamber by means of energy absorbed due to heating. For example the cooking vessel could be provided for introduction into at least one cooking chamber, in particular of a cooking appliance configured as an oven. The cooking vessel is preferably provided for positioning on at least one positioning plate, in particular for the purpose of heating. The cooking vessel could comprise for example at least one pot and/or at least one pan and/or at least one baking sheet.

The expression that an object “at least partially” delimits the food receiving chamber means in particular that the object delimits the food receiving chamber alone or together with at least one further object. The object and/or the further object could be for example the cooking vessel and/or at least one cooking vessel lid and/or at least one housing unit, in particular of the cooking vessel device.

A “stirring unit” refers in particular to a unit, which is provided in particular to stir and/or mix at least one food and which stirs and/or mixes at least one food in particular in the operating state, in particular by means of the stirring element.

A “stirring element” refers in particular to an element, which stirs and/or mixes at least one food in the operating state and which is arranged in particular to make at least sectional contact with the food in the operating state. In particular the stirring element is provided to stir and/or mix at least one food. The expression that the stirring element is arranged to make “at least sectional” contact with the food in the operating state means in particular that the stirring element comprises at least one section which is arranged in contact with the food in the operating state and could in particular have at least one further section which could be free from contact with the food in the operating state.

The section and the further section could be arranged for example on opposing end regions of the stirring element. For example the stirring element could be connected to the retaining element and/or supported on the retaining element by means of the further section. The section could be arranged for example on an end region of the stirring element facing away from the retaining element in the operating state. In particular the further section could be arranged on an end region of the stirring element facing the retaining element in the operating state.

A “retaining element” refers in particular to an element, which at least partially supports and/or retains the stirring element in the operating state and which at least partially absorbs in particular at least the weight of the stirring element in the operating state and transfers it in particular to at least one further unit. The further unit could be for example the cooking vessel and/or at least one housing unit, in particular of the cooking vessel device.

The expression that the retaining element “at least partially” supports and/or retains the stirring element in the operating state means in particular that the retaining element supports and/or retains the stirring element alone or together with at least one further retaining element in the operating state. The expression that the retaining element “at least partially” absorbs at least the weight of the stirring element in the operating state and transfers it in particular to at least one further unit means in particular that the retaining element absorbs a percentage of the weight of the stirring element of at least 40%, in particular at least 50%, advantageously at least 60%, particularly advantageously at least 70%, preferably at least 80% and particularly preferably at least 90% in the operating state and transfers it in particular to the further unit.

For example the retaining element and the stirring element could be configured as a single piece. “As a single piece” means in particular connected with a material fit, for example by means of a welding process, an adhesion process, an injection process and/or another process that appears expedient to the person skilled in the art and/or advantageously formed in one piece, for example by being produced from one casting and/or being produced using a single or multiple component injection method and advantageously from a single workpiece. The retaining element and the stirring element are preferably configured differently from one another and are in particular each configured as independent parts.

In particular the stirring element is fastened to the retaining element for example in such a manner that it cannot be released non-destructively or advantageously in such a manner that it can be released non-destructively in the operating state. The stirring element could be fastened to the retaining element for example in such a manner that it can be released non-destructively and advantageously in such a manner that it can be released without tools in the operating state. For example the stirring element could be fastened to the retaining element by means of at least one screw connection and/or by means of at least one connection produced by clamping and/or by means of at least one plug-in connection and/or by means of at least one latching connection in the operating state.

A “drive unit” refers in particular to a unit, which provides at least one drive torque and/or at least one drive force to move the retaining element along the movement path in the operating state. For example the drive unit could have at least one drive motor, in particular to move the retaining element along the movement path, said drive motor in particular providing the drive torque and/or drive force and being configured in particular as an electric motor.

The movement path could be for example an open path. For example the drive unit could move the retaining element along an open movement path and in particular along a route that extends in particular between at least two, in particular different, end points of the movement path, in the operating state. In particular the drive unit could stop the movement of the retaining element along the open movement path in at least one end point and advantageously in each of the end points, in order in particular to reverse movement of the retaining element.

The movement path is preferably a closed path. The drive unit moves the retaining element in particular along a closed movement path in the operating state, in particular preventing reversal and/or halting and/or stopping. In particular the drive unit moves the retaining element periodically along the movement path in the operating state.

The movement path could have for example a length of at least 0.1 cm, in particular at least 0.3 cm, advantageously at least 0.5 cm, particularly advantageously at least 0.8 cm, preferably at least 1 cm and particularly preferably at least 3 cm.

“Provided” means in particular specifically programmed, designed and/or equipped. That an object is provided for a specific function means in particular that the object fulfils and/or performs said specific function in at least one application and/or operating state.

It is further proposed that the movement path has a length of at least 5 cm, in particular at least 10 cm, advantageously at least 20 cm, particularly advantageously at least 30 cm, preferably at least 40 cm and particularly preferably at least 50 cm. In particular the drive unit moves the retaining element along a movement path with a length of at least 5 cm, in particular at least 10 cm, advantageously at least 20 cm, particularly advantageously at least 30 cm, preferably at least 40 cm and particularly preferably at least 50 cm in the operating state. In particular the movement path has a length of maximum 300 cm, in particular maximum 250 cm, advantageously maximum 200 cm, particularly advantageously maximum 150 cm, preferably maximum 120 cm and particularly preferably maximum 100 cm. This allows the retaining element in particular to be moved over a large area, in particular allowing advantageous and/or thorough mixing and/or stirring.

It is also proposed that the movement path has a diameter of at least 3 cm, in particular at least 5 cm, advantageously at least 10 cm, particularly advantageously at least 12 cm, preferably at least 15 cm and particularly preferably at least 20 cm. In particular the drive unit moves the retaining element along a movement path with a diameter of at least 3 cm, in particular at least 5 cm, advantageously at least 10 cm, particularly advantageously at least 12 cm, preferably at least 15 cm and particularly preferably at least 20 cm in the operating state. In particular the movement path has a diameter of maximum 60 cm, in particular maximum 50 cm, advantageously maximum 45 cm, particularly advantageously maximum 40 cm, preferably maximum 35 cm and particularly preferably maximum 32 cm. A “diameter” here refers in particular to a maximum extension of a largest circle still just containing the movement path. This allows an optimal stirring process to be achieved, with food in particular being optimally mixed and/or stirred.

It is further proposed that the diameter corresponds at least substantially to a cooking vessel diameter of the cooking vessel. In the operating state the drive unit moves the retaining element in particular along a movement path, the diameter of which corresponds at least substantially to a cooking vessel diameter of the cooking vessel. The expression that a first diameter corresponds “at least substantially” to a second diameter means in particular that the first diameter deviates from the second diameter by a value of maximum 12%, in particular maximum 10%, advantageously maximum 8%, particularly advantageously maximum 6%, preferably maximum 4% and particularly preferably maximum 2% of a value of the second diameter, it being possible in particular for said second diameter to be larger than the first diameter. The movement path in particular has a length that corresponds at least substantially to a circumference of an internal wall of the cooking vessel delimiting the food receiving chamber. This allows the cooking vessel to be filled in a simple and/or uncomplicated manner, allowing significant ease of operation.

For example the movement path could be oval-shaped and/or in the manner of an oval, being for example elliptical and/or in the manner of an ellipse. The movement path is preferably circular and/or in the manner of a circle. In the operating state the drive unit moves the retaining element in particular along a circular and/or circle-like movement path. This results in a structurally simple movement path. In particular it allows simple programming of a control unit controlling and/or regulating the movement along the movement path, keeping production costs in particular low.

It is also proposed that the cooking vessel device comprises at least one housing unit, which is provided to be positioned on the cooking vessel and in which the drive unit in particular is at least partially integrated. In particular the housing unit has at least one coupling unit, which is provided in particular for coupling to the cooking vessel, in particular to at least one cooking vessel coupling unit of the cooking vessel, in particular in such a manner that it can be released without tools. The cooking vessel in particular comprises at least one and advantageously at least the cooking vessel coupling unit, which is provided in particular for coupling to the coupling unit, in particular of the housing unit, in particular in such a manner that it can be released without tools. The expression that the drive unit is “at least partially” integrated in a unit means in particular that the drive unit comprises at least one element, which is integrated in the unit, and could comprise in particular at least one further element, which could be arranged outside the unit and/or could be located in particular outside the unit. The unit in which the drive unit could in particular be at least partially integrated could be for example the housing unit and/or at least one handle, in particular of the cooking vessel device. This results in particularly significant ease of operation and/or allows a structurally simple connection between the housing unit and the cooking vessel. In particular a large number of automatic cooking operations can be supported, as the stirring unit can be used in particular in cooking operations, resulting in a high degree of flexibility and/or a high level of operator satisfaction. In a mounted state in particular it can give an impression of in particular just one, compact unit, clearly distinguishing it in particular from embodiments with a number of individual components.

The housing unit could be configured for example as one part. The housing unit is preferably configured at least in two parts and has in particular at least one housing base element and in particular at least one housing element. In the operating state the housing base element is arranged in particular on a side of the housing unit facing the cooking vessel. In particular in the operating state the housing element is arranged on a side of the housing unit facing away from the cooking vessel. In the operating state the housing base element and the housing element define and/or delimit in particular at least one hollow space, in which in particular at least one transmission element of the drive unit is arranged. In particular the housing unit, in particular the housing base element and/or the housing element, is made at least largely of at least one plastic. This allows a high degree of flexibility and/or simple assembly and/or disassembly.

The cooking vessel device could be configured for example as a retrofit unit, in particular for the cooking vessel, and could be provided in particular for connection to the cooking vessel in particular releasably and advantageously in such a manner that it can be released without tools. Simple cleaning and/or significant ease of operation in particular can be achieved in particular by a releasable coupling, in particular between the cooking vessel device and the cooking vessel.

The housing unit and/or in particular the coupling unit could comprise for example at least one coupling element, which could be provided in particular for coupling to the cooking vessel, in particular to the cooking vessel coupling unit. The coupling element could be provided for example for coupling with a force fit and/or form fit to the cooking vessel, in particular to the cooking vessel coupling unit.

The housing unit and/or coupling unit could for example be provided, in particular solely, for coupling to the cooking vessel and/or to the cooking vessel coupling unit. The housing unit and/or coupling unit could be provided in particular for coupling to a cooking vessel with a predefined cooking vessel diameter. The coupling unit can advantageously be tailored to different cooking vessel diameters.

It is further proposed that the housing unit comprises at least one bearing surface, which is provided to support at least one cooking vessel lid. In particular in the operating state, in which the cooking vessel lid rests in particular on the bearing surface, the cooking vessel lid at least partially delimits the food receiving chamber. The cooking vessel lid is provided in particular to cover and/or close the food receiving chamber, in particular on a side at least opposite a cooking vessel bottom of the cooking vessel. A “bearing surface” of the housing unit refers in particular to a partial surface region of the housing unit, which is arranged in at least sectional contact with the cooking vessel lid in the operating state and which in particular at least partially absorbs the weight of the cooking vessel lid in the operating state and transfers it in particular to at least one further unit, in particular to the cooking vessel. This allows the cooking vessel lid to be arranged on the housing unit in particular in a structurally simple manner. In particular an operator is able to close at least one and advantageously the food receiving chamber with the cooking vessel lid during a cooking process, resulting in particular in significant ease of operation and/or an environmentally friendly embodiment.

It is also proposed that the housing unit at least largely encloses and/or defines and/or delimits at least one fill opening, which is provided for inserting food into at least one food receiving chamber, in particular into at least the food receiving chamber, in at least one plane. In particular in the operating state food can be introduced and/or inserted and/or added into the food receiving chamber through the fill opening, in particular by the operator. The expression that the housing unit “at least largely” encloses at least one fill opening in at least one plane means in particular that the housing unit encloses the fill opening in the plane over an angular range of at least 90°, in particular at least 180°, advantageously at least 270°, particularly advantageously at least 300°, preferably at least 330° and particularly preferably at least 350° in relation to a geometric center point and/or center of gravity of the fill opening in the plane. This results in particular in significant ease of operation and/or flexibility in a structurally simple manner.

The opening diameter of the fill opening could be for example smaller, in particular substantially smaller, than the cooking vessel diameter of the cooking vessel. A diameter of the fill opening preferably corresponds at least substantially to a cooking vessel diameter of the cooking vessel. This means in particular that the fill opening can be the maximum size, allowing food to be introduced and/or inserted into the food receiving chamber in particular easily and/or in an uncomplicated manner.

It is further proposed that the cooking vessel device comprises at least one, in particular electrical, energy storage unit, which supplies the drive unit with, in particular electrical, energy in the operating state. An, in particular electrical, “energy storage unit” refers to an, in particular electrical, unit which is provided for the storage of, in particular electrical, energy. The electrical energy storage unit could comprise for example at least one accumulator and/or at least one capacitor. The electrical energy storage unit could be provided for example for the storage of electrical voltage. For example the electrical energy storage unit could be different from a coil and could be provided in particular for the storage of energy in a manner that is different from electrical current. This means there is no need for connection to an external energy source to operate the drive unit, resulting in an independent device and/or a simple energy supply.

For example the energy storage unit could be integrated at least partially, in particular at least largely and advantageously completely in the housing unit. The cooking vessel device preferably comprises at least one handle, in which the drive unit is at least partially integrated and in which in particular the energy storage unit is integrated at least partially, in particular at least largely and advantageously completely. “At least largely” means in particular by a percentage, in particular a mass percentage and/or volume percentage and/or a percentage of a number, of at least 70%, in particular at least 80%, advantageously at least 90% and preferably at least 95%. A “handle” refers in particular to a unit, which is provided for arrangement on the cooking vessel and/or on the housing unit and advantageously for fastening to the cooking vessel and/or to the housing unit and which, in particular in at least one position connected to the cooking vessel and/or the housing unit, is provided in particular for activation by an operator, in particular for the purpose of moving and/or handling the cooking vessel. The handle in particular defines at least one grip surface, which is provided in particular for contact and/or touch by the operator, in particular for the purpose of moving and/or handling the cooking vessel. In particular the handle is provided to be mounted in an in particular releasable manner on the cooking vessel and/or on the housing unit. This means that at least one part of the drive unit is arranged in particular in a secure manner, with the result in particular that there is little probability of damage to said part of the drive unit. The cooking vessel can in particular be handled easily.

It is further proposed that the drive unit comprises at least one gear drive. The drive unit in particular comprises at least one transmission element, which is connected in particular in a rotationally fixed manner to the retaining element and which transmits and/or supplies the drive torque to the retaining element in particular in the operating state. The transmission element in particular comprises at least one toothed wheel and is in particular configured as a toothed wheel. In particular the drive unit comprises at least one drive element, which is provided in particular to supply and/or transmit at least one drive torque in particular to the transmission element and which supplies and/or transmits at least one drive torque, in particular to the transmission element, in particular in the operating state. The drive element could be coupled for example to the drive motor of the drive unit and could advantageously be driven by the drive motor in the operating state. The drive element in particular comprises at least one toothed wheel and is in particular configured as a toothed wheel. In particular the drive element is coupled to the transmission element in the operating state and in particular at least partially engages with the transmission element. In the operating state the drive element and/or the transmission element is integrated in particular at least partially, advantageously at least largely and preferably completely in the housing unit. This allows the retaining element to be driven optimally in particular in a structurally simple manner, resulting in particular in significant ease of operation.

For example the drive unit could, in particular solely, comprise the drive element and be in particular free of stabilization elements. The drive unit preferably comprises at least one stabilization element, which is provided to stabilize the retaining element on the movement path and in particular at least to assist the drive unit as the retaining element moves on the movement path. In particular the stabilization element stabilizes the retaining element on the movement path in the operating state and assists the drive unit in particular as the retaining element moves on the movement path. For example the stabilization element could be part of at least one slide bearing and/or at least one roller bearing and/or at least one ball bearing. The stabilization element could in particular be part of at least one gear drive and in particular comprise at least one toothed wheel and in particular be configured as a toothed wheel. In the operating state the stabilization element is integrated in particular at least partially, advantageously at least largely and preferably completely in the housing unit. The drive unit could in particular comprise at least two, in particular at least three, advantageously at least four, particularly advantageously at least six, preferably at least eight and particularly preferably multiple stabilization elements. This in particular allows stable movement of the retaining element on the movement path and/or makes the occurrence of significant mechanical friction highly unlikely, thereby in particular guaranteeing optimal movement on the movement path. In particular it allows quiet operation of the stirring unit and/or prevents damage to structural units, in particular due to significant mechanical friction.

For example the stabilization element could be part of at least one slide bearing, for example at least one slide bearing with solid friction and/or with liquid friction and/or with mixed friction. The stabilization element could for example be configured at least largely from a material with low mechanical friction. For example the stabilization element could have a pin-like form. The stabilization element is preferably part of at least one roller bearing. In particular the cooking vessel device comprises at least one roller bearing, in particular at least the roller bearing, which is configured in particular as a ball bearing. The stabilization element could have a roller-like or cylindrical form for example. The stabilization element is preferably part of at least one ball bearing. The stabilization element in particular has at least a ball-like form. In particular in the operating state the stabilization element prevents movement of the transmission element in a horizontal plane. In particular the stabilization element minimizes friction loss during movement on the movement path, in particular by minimizing friction loss between the transmission element and the housing unit, in particular the housing base element and/or the housing element. This results in a particularly low level of mechanical friction, allowing in particular optimized movement of the retaining element on the movement path and/or quiet movement of the retaining element on the movement path. The low level of mechanical friction in particular allows an energy-saving embodiment and/or a high level of energy efficiency and/or a drive with low drive energy to be achieved. The low level of mechanical friction in particular results in a low level of material wear and/or a sustainable embodiment.

The cooking vessel device, in particular the roller bearing of the cooking vessel device, in particular has at least one bearing element per stabilization element, said bearing element in particular supporting the stabilization element at least in sections. The bearing element defines and/or delimits in particular sections of at least one receiving region, in which the stabilization element is supported at least in sections in the operating state. In the operating state the stabilization element could in particular be arranged in the receiving region with a form fit.

In the operating state the housing base element and the housing element are in particular connected to one another and advantageously fastened to one another and in particular delimit the hollow space, in particular at least largely. In particular in the operating state the transmission element is in particular sandwiched within the hollow space, allowing in particular movement of the transmission element with little friction, in particular due to the roller bearing.

It is further proposed that the stabilization element is supported at least in sections in at least one receiving region of the housing unit, in particular of the housing base element of the housing unit. The bearing element and the housing unit, in particular the bearing element and the housing base element, are in particular configured as a single piece. In particular the bearing element is arranged in the manner of a projection on the housing base element. In particular the receiving region is configured as a well-like hollow. The expression that the stabilization element is supported “at least in sections” in at least one receiving region means in particular that at least one partial region of the stabilization element is supported in the receiving region and at least one further partial region of the stabilization element is supported outside the receiving region. This in particular allows optimized support for the stabilization element. In particular simple assembly and/or disassembly is possible, as the stabilization element can be mounted in particular in a fixed position.

The drive unit in particular has at least one guide path, in which in particular at least sections of the stabilization element, which is supported at least in sections in the receiving region of the housing unit, engage. In particular the transmission element of the drive unit comprises the guide path and defines the guide path in particular at least in sections, in particular at least largely and advantageously completely. In the operating state the guide path is arranged in particular on a side of the transmission element facing the housing base element.

It is also proposed that stabilization element is supported at least in sections in at least one receiving region of the drive unit, in particular of the transmission element of the drive unit. For example the stabilization element could be supported either in the receiving region of the housing unit or in the receiving region of the drive unit. The drive unit preferably comprises at least two stabilization elements, of which at least one stabilization element is supported in the receiving region of the housing unit and at least one other is supported in the receiving region of the drive unit. The bearing element and the drive unit, in particular the bearing element and the transmission element, are in particular configured as a single piece. In particular the bearing element is arranged in the manner of a projection on the transmission element. This in particular allows the stabilization element to be supported particularly optimally, resulting in particular in a low level of wear and/or a sustainable embodiment.

The housing unit in particular has at least one guide path, in which in particular at least sections of the stabilization element, which is supported in particular at least in sections in the receiving region of the drive unit, engage. In particular the housing element of the housing unit comprises the guide path and defines the guide path, in particular at least in sections, in particular at least largely and advantageously completely. In the operating state the guide path is arranged in particular on a side of the housing element facing the transmission element.

It is also proposed that the stirring element is configured as a wall-based stirring element and in particular the retaining element is configured as a wall-based retaining element. A “wall-based” element refers in particular to an element, which in the operating state, in which the element moves in particular along the movement path, moves in particular along a wall, in particular a side wall, of the cooking vessel. In particular in the operating state the, in particular wall-based, element is at a maximum distance of maximum 5 cm, in particular maximum 4 cm, advantageously maximum 3 cm, particularly advantageously maximum 2 cm, preferably maximum 1 cm and particularly preferably maximum 0.5cm from the wall, in particular the side wall, of the cooking vessel. The movement path is aligned in particular at least substantially parallel to the wall, in particular the side wall, of the cooking vessel and in particular runs in proximity to the wall, in particular the side wall, of the cooking vessel. In particular in the operating state the drive unit moves a region of a stirring blade of the stirring element facing the retaining element on a path with a larger diameter than a region of the stirring blade of the stirring element facing away from the retaining element. This results in particular in a particularly advantageous construction, as it is unlikely that the stirring element will influence a cooking process and/or further parts. This prevents an operator being hampered by the stirring element, as would be the case for example if the stirring element were arranged in the center of the cooking vessel.

A particularly optimal construction can be achieved in particular by a cooking system with at least one, in particular at least the, cooking vessel and with at least one, in particular at least the, cooking vessel device, advantageously positioned on the cooking vessel. The cooking vessel device is configured in particular as a retrofit part.

The cooking vessel device here should not be restricted to the application and embodiment described above. In particular the cooking vessel device can have a number of individual elements, parts and units that is different from the number cited herein in order to comply with a mode of operation described herein.

Further advantages will emerge from the description of the drawing which follows. The drawing shows exemplary embodiments of the invention. The drawing, description and claims contain numerous features in combination. The person skilled in the art will expediently also consider the features individually and bring them together in useful further combinations.

In the drawing:

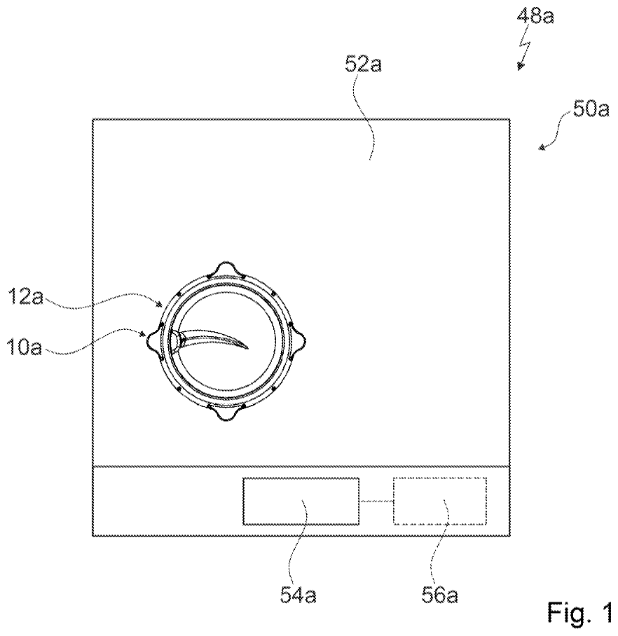

FIG. 1 shows a schematic plan view of a cooking system having a cooking appliance, a cooking vessel and a cooking vessel device,

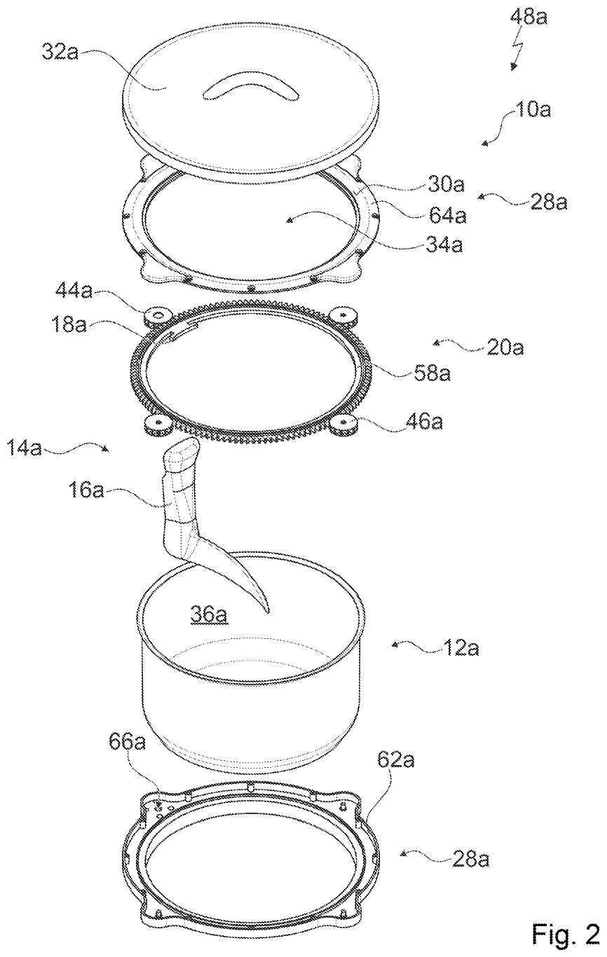

FIG. 2 shows an exploded view of the cooking vessel, the cooking vessel device and a cooking vessel lid of the cooking system,

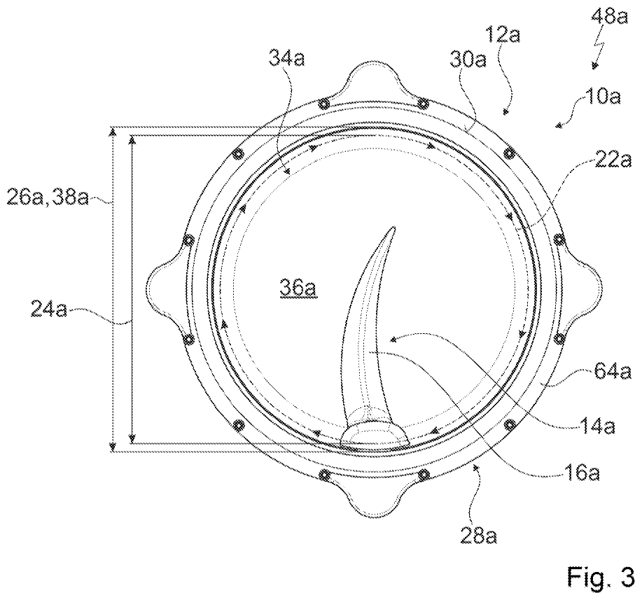

FIG. 3 shows a plan view of the cooking vessel and the cooking vessel device,

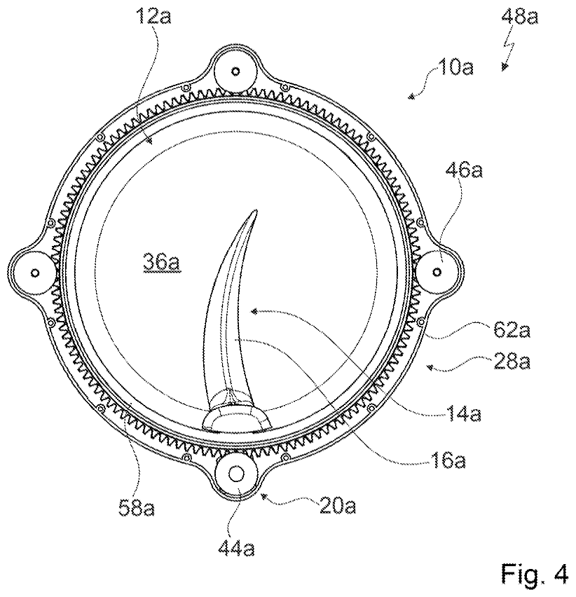

FIG. 4 shows a plan view of the cooking vessel and the cooking vessel device, a housing element of a housing unit of the cooking vessel device not being shown,

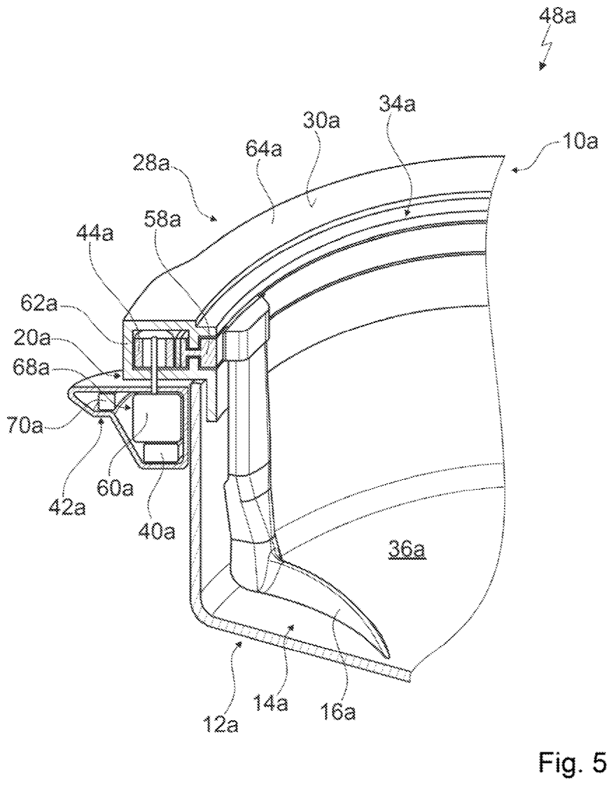

FIG. 5 shows a partial schematic sectional view of a detail of the cooking vessel and the cooking vessel device,

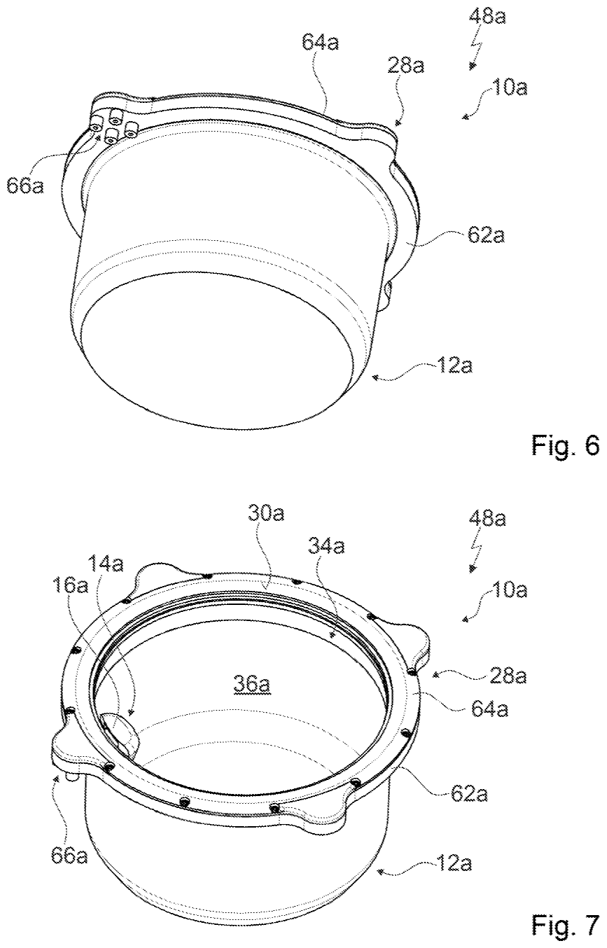

FIG. 6 shows a perspective view obliquely from below of the cooking vessel and the cooking vessel device,

FIG. 7 shows a perspective view obliquely from above of the cooking vessel and the cooking vessel device,

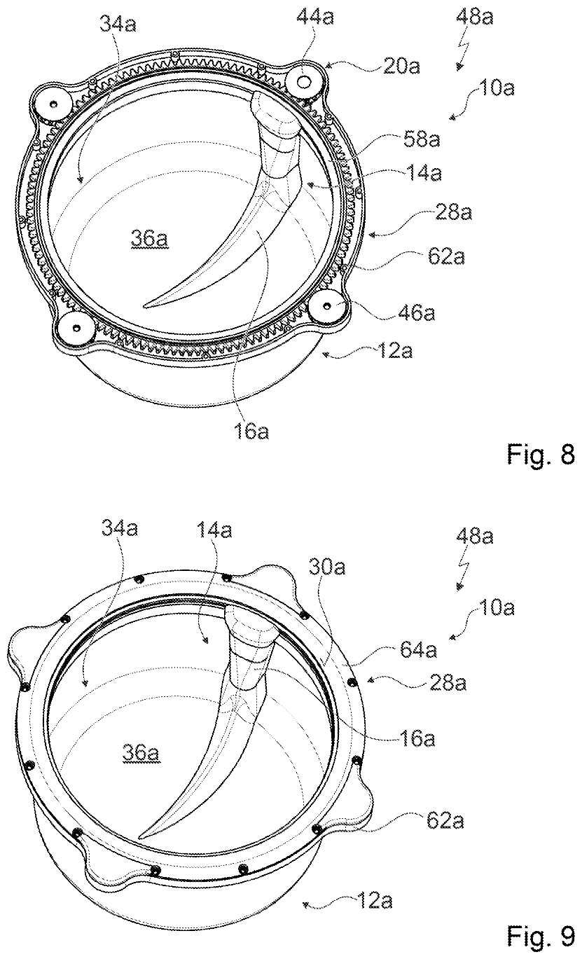

FIG. 8 shows a perspective view obliquely from above of the cooking vessel and the cooking vessel device, a housing element of a housing unit of the cooking vessel device not being shown,

FIG. 9 shows a perspective view obliquely from above of the cooking vessel and the cooking vessel device,

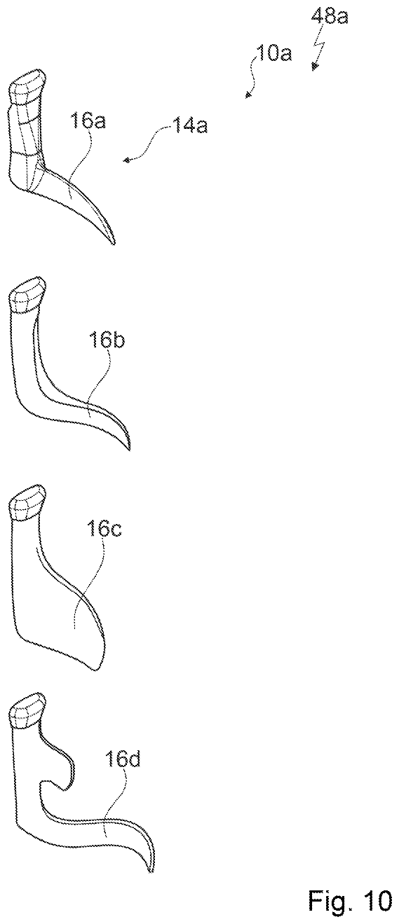

FIG. 10 shows a perspective view of four different stirring elements of a stirring unit of the cooking vessel device,

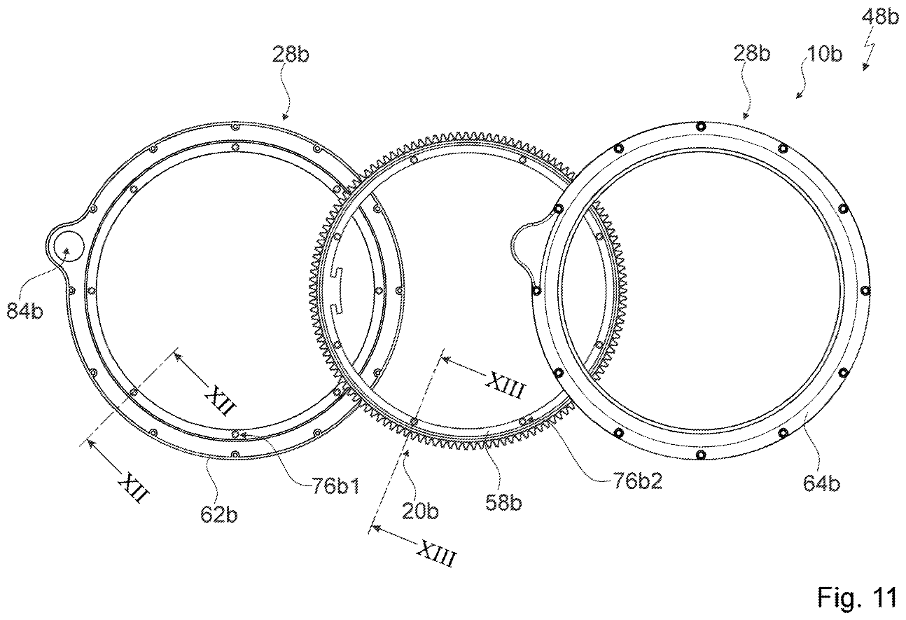

FIG. 11 shows a schematic plan view of a detail of a housing unit and a drive unit of an alternative cooking vessel device of an alternative cooking system in an unmounted state,

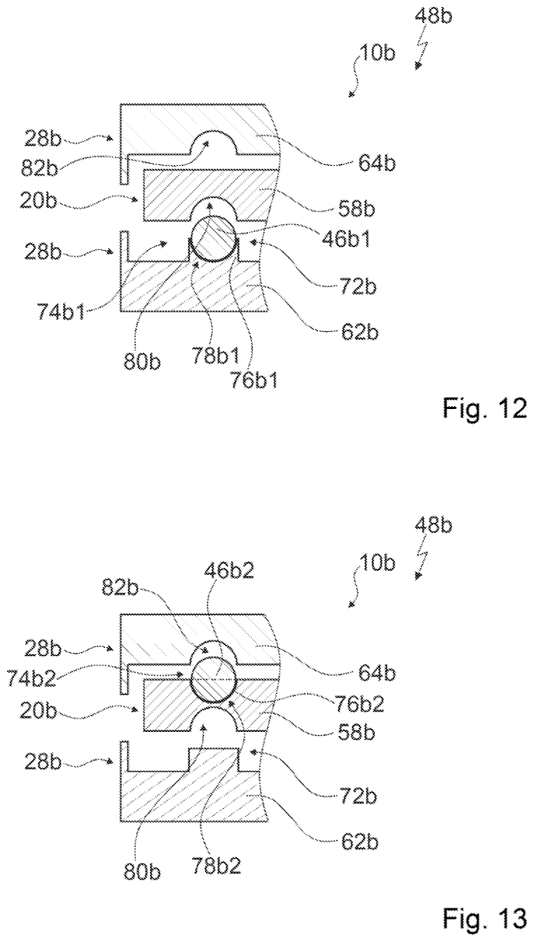

FIG. 12 shows a section along the line XII-XII from FIG. 11 and

FIG. 13 shows a section along the line XIII-XIII from FIG. 11.

FIG. 1 in particular shows a cooking system 48a, which is configured in particular as an induction cooking system. In the present exemplary embodiment the cooking system 48a is configured in particular as a cooktop system and in particular as an induction cooktop system. Alternatively the cooking system 48a could be configured for example as an oven system, in particular as an induction oven system.

The cooking system 48a in particular comprises at least one and advantageously just one cooking appliance 50a. The cooking appliance 50a is configured in particular as an induction cooking appliance. The cooking appliance 50a could be configured for example as an oven, in particular as an induction oven. In the present exemplary embodiment the cooking appliance 50a is configured in particular as a cooktop and in particular as an induction cooktop. The cooking appliance 50a is configured and/or provided in particular specifically for the cooking system 48a.

The cooking system 48a in particular comprises at least one and advantageously just one appliance plate 52a. In at least one mounted state the appliance plate 52a in particular forms a visible surface, which is arranged facing an operator in particular in the mounted state. In the present exemplary embodiment the appliance plate 52a is configured as a positioning plate.

The appliance plate 52a is provided in particular for the positioning of cooking vessels 12a, in particular for the purpose of heating the cooking vessel 12a. In the present exemplary embodiment the appliance plate 52a is configured in particular as a cooktop plate. The appliance plate 52 is in particular part of the cooking appliance 50a. The cooking appliance 50a in particular comprises the appliance plate 52a.

In particular the cooking system 48a comprises at least one and in particular just one cooking vessel 12a, in particular at least the and advantageously just the cooking vessel 12a. The cooking vessel 12a is provided in particular for positioning on the appliance plate 52a, in particular for the purpose of heating the cooking vessel 12a.

The cooking vessel 12a in particular delimits at least one and advantageously just one food receiving chamber 36a at least partially and advantageously at least largely. The food receiving chamber 36a is provided in particular to receive food, in particular for the purpose of cooking and/or heating.

In particular the cooking vessel 12a has at least one cooking vessel diameter 26a (see FIG. 3). For example the cooking vessel diameter 26a could have a value of at least 8 cm, in particular at least 10 cm, advantageously at least 12 cm, particularly advantageously at least 15 cm, preferably at least 18 cm and particularly preferably at least 21 cm. The cooking vessel diameter 26a could for example have a value of maximum 50 cm, in particular maximum 45 cm, advantageously maximum 40 cm, particularly advantageously maximum 35 cm, preferably maximum 32 cm and particularly preferably maximum 28 cm. In the present exemplary embodiment a cooking vessel diameter 26a in particular is assumed in the following, having a value of at least substantially 28 cm, without loss of generality.

“At least substantially” here means in particular that a value deviates in particular by maximum 25%, preferably maximum 10% and particularly preferably maximum 5% from a predefined value.

The cooking system 48a in particular comprises at least one heating unit (not shown). In the present exemplary embodiment the cooking system 48a in particular has a plurality of heating units.

Alternatively the cooking system 48a could comprise for example a smaller number of heating units, for example just one heating unit and/or at least two, in particular at least four, advantageously at least eight, particularly advantageously at least twelve and preferably multiple heating units. The heating units could be arranged for example in the form of a matrix. Only one of the heating units in particular is described in the following.

In an installed position the heating unit is arranged in particular below the appliance plate 52a. The heating unit is provided in particular to heat at least one cooking vessel 12a positioned on the appliance plate 52a above the heating unit. The heating unit is configured in particular as an induction heating unit. The heating unit is in particular part of the cooking appliance 50a. The cooking appliance 50a in particular comprises the heating unit.

The cooking system 48a has in particular at least one and advantageously just one appliance operator interface 54a (see FIG. 1). The appliance operator interface 54a is provided in particular for inputting and/or selecting operating parameters, for example a heat output and/or heat output density and/or heating zone. The appliance operator interface 54a is provided in particular for outputting a value of an operating parameter to an operator. The appliance operator interface 54a is in particular part of the cooking appliance 50a. The cooking appliance 50a in particular comprises the appliance operator interface 54a.

The cooking system 48a has in particular at least one and advantageously just one appliance control unit 56a. The appliance control unit 56a controls and/or regulates an appliance main function in particular in at least one operating state. The appliance control unit 56a is provided in particular to perform actions and/or change settings as a function of operating parameters input using the appliance operator interface 54a.

The appliance control unit 56a is in particular part of the cooking appliance 50a. The cooking appliance 50a in particular comprises the appliance control unit 56a. The appliance control unit 56a in particular regulates an energy supply to the heating unit, in particular to heat the cooking vessel 12a, in the operating state.

The cooking system 48a in particular comprises at least one and advantageously just one cooking vessel device 10a, in particular for the cooking vessel 12a. The cooking vessel device 10a is provided and/or configured in particular specifically for the cooking vessel 12a. In particular the cooking vessel device 10a is tailored specifically to the cooking vessel 12a. The cooking vessel device 10a is configured in particular for coupling to the cooking vessel 12a and advantageously as an accessory unit for the cooking vessel 12a.

The cooking vessel device 10a in particular has at least one and advantageously just one stirring unit 14a (see FIGS. 2 to 5 and 7 to 10). In the operating state the stirring unit 14a in particular mixes food present in the food receiving chamber 36a. In particular the stirring unit 14a comprises at least one stirring element 16a, which is arranged in particular in contact with food present in the food receiving chamber 36a in the operating state.

For example the stirring unit 14a could comprise just one, in particular a single, stirring element 16a. Alternatively or additionally the stirring unit 14a could in particular comprise in particular at least two, in particular at least three, advantageously at least four, particularly advantageously at least five, preferably at least six and particularly preferably multiple stirring elements 16a, 16b, 16c, 16d (see FIG. 10).

In the present exemplary embodiment the stirring unit 14a in particular comprises four stirring elements 16a, 16b, 16c16d. In particular each of the stirring elements 16a, 16b, 16c, 16d is provided to stir and/or mix food present in the food receiving chamber 36a. The stirring elements 16a, 16b, 16c, 16d differ in particular in respect of shape and/or in respect of the configuration of the stirring blade of the respective stirring element 16a, 16b, 16c16d. Only one of the stirring elements 16a, 16b, 16c, 16d is described in the following.

The stirring unit 14a in particular comprises at least one and advantageously just one retaining element 18a (see FIG. 2). In the operating stated the retaining element 18a in particular retains the stirring element 16a. In the present exemplary embodiment the stirring element 16a and the retaining element 18a are in particular connected to one another and advantageously fastened to one another in the operating state, in particular by means of a form-fit connection. Alternatively or additionally the stirring element 16a and the retaining element 18a could in particular be connected to one another and advantageously fastened to one another in the operating state, in particular by means of a force fit connection. Alternatively the stirring element 16a and the retaining element 18a could in particular be configured as a single piece.

The cooking vessel device 10a in particular comprises at least one and advantageously just one drive unit 20a (see FIGS. 2, 4, 5 and 8). In particular the drive unit 20a is provided to drive the stirring unit 14a, in particular the stirring element 16a and/or the retaining element 18a. In the operating state the drive unit 20a in particular drives the stirring unit 14a, in particular the stirring element 16a and/or the retaining element 18a.

In the operating state the drive unit 20a moves the retaining element 18a in particular along a movement path 22a (see FIG. 3). In particular the movement path 22a has a length of at least 1 cm, in particular at least 3 cm, advantageously at least 5 cm, particularly advantageously at least 10 cm, preferably at least 20 cm and particularly preferably at least 30 cm. In the present exemplary embodiment, in which the cooking vessel diameter 26a in particular has a value of 28 cm, the movement path 22a in particular has a length of at least substantially 85 cm.

In particular the movement path 22a has a diameter 24a of at least 0.5 cm, in particular at least 1 cm, advantageously at least 3 cm, particularly advantageously at least 5 cm, preferably at least 10 cm and particularly preferably at least 20 cm. In the present exemplary embodiment, in which the cooking vessel diameter 26a in particular has a value of 28 cm, the movement path 22a in particular has a diameter 24a of at least substantially 27 cm.

The cooking vessel diameter 26a and the diameter 24a of the movement path 22a are in particular at least substantially identical. In particular the diameter 24a of the movement path 22a corresponds at least substantially to the cooking vessel diameter 26a of the cooking vessel 12a. The cooking vessel diameter 26a is in particular slightly larger than the diameter 24a of the movement path 22a.

In the present exemplary embodiment the movement path 22a is in particular circle-like and advantageously circular. Alternatively or additionally the movement path 22a could be in particular in the manner of an oval and/or ellipse, advantageously oval-shaped and/or elliptical.

In the operating state, in which the drive unit 20a moves the retaining element 18a in particular along the movement path 22a, the drive unit 20a moves the stirring element 16a at least partially along the movement path 22a in particular by means of the retaining element 18a. In particular in the operating state the drive unit 20a in particular moves at least one part of the stirring element 16a facing the retaining element 18a along the movement path 22a in the operating state. The stirring element 16a is configured in particular as a wall-based stirring element 16a.

In the present exemplary embodiment the drive unit 20a in particular comprises at least one and advantageously just one gear drive (see FIGS. 2, 4, 5 and 8). In particular the drive unit 20a is configured as a and advantageously as the gear drive.

The drive unit 20a in particular comprises at least one and advantageously just one transmission element 58a. In the operating state the transmission element 58a in particular transmits a drive torque to the retaining element 18a. In particular the transmission element 58a and the retaining element 18a are connected to one another in a rotationally fixed manner. In the present exemplary embodiment the transmission element 58a and the retaining element 18a are configured in particular as a single piece.

The transmission element 58a in particular comprises at least one toothed wheel and is configured in particular as a and advantageously as the toothed wheel. The transmission element 58a in particular has a transmission diameter, which corresponds in particular at least substantially to the cooking vessel diameter 26a.

The drive unit 20a in particular comprises at least one and advantageously just one drive element 44a. In the operating state the drive element 44a drives the transmission element 58a in particular and the retaining element 18a in particular by means of the transmission element 58a.

The drive unit 20a in particular comprises at least one and advantageously just one drive motor 60a (see FIG. 5). In the operating state the drive element 44a is coupled to the drive motor 60a in a rotationally fixed manner. In the operating state the drive motor 60a in particular transmits a drive torque to the drive element 44a, which transmits the drive torque in particular to the transmission element 58a and in particular to the retaining element 18a, in particular by means of the transmission element 58a.

The drive element 44a in particular comprises at least one toothed wheel and is configured in particular as a and advantageously as the toothed wheel. The drive element 44a in particular has a drive element diameter, which is in particular substantially smaller than the cooking vessel diameter 26a. For example the drive element diameter could have a value of maximum 8 cm, in particular maximum 5 cm, advantageously maximum 4 cm, particularly advantageously maximum 3 cm, preferably maximum 2 cm and particularly preferably maximum 1 cm.

In the operating state the drive element 44a and the transmission element 58a engage, in particular at least in sections, in particular with one another (see FIGS. 2, 4, 5 and 8). In particular the drive element 44a and the transmission element 58a engage with one another, at in particular at least in sections, in the operating state.

The drive unit 20a comprises in particular at least one stabilization element 46a (see FIGS. 2, 4 and 8), in particular in addition to the drive element 44a . For example the drive unit 20a could comprise just one, in particular a single, stabilization element 46a. Alternatively or additionally the drive unit 20a could in particular comprise in particular at least two, in particular at least three, advantageously at least four, particularly advantageously at least five, preferably at least six and particularly preferably multiple stabilization elements 46a. In the present exemplary embodiment the drive unit 20a in particular comprises at least three and advantageously just three stabilization elements 46a. Where multiple objects are present, only one is shown with a reference character in the figures.

The drive element 44a and the stabilization elements 46 are, in particular at least substantially, in particular evenly distributed over a circumference of the transmission element 58a . Only one of the stabilization elements 46a is described in the following.

The stabilization element 46a is configured to be at least substantially and advantageously precisely identical to the drive element 44a in particular in respect of configuration and/or form and/or shape.

The stabilization element 46a in particular comprises at least one toothed wheel and is configured in particular as a and advantageously as the toothed wheel. The stabilization element 46a in particular has a stabilization element diameter, which is in particular substantially smaller than the cooking vessel diameter 26a. For example the stabilization element diameter could have a value of maximum 8 cm, in particular maximum 5 cm, advantageously maximum 4 cm, particularly advantageously maximum 3 cm, preferably maximum 2 cm and particularly preferably maximum 1 cm.

The stabilization element 46a and the transmission element 58a in particular engage at least in sections, in particular with one another, in the operating state. In particular the stabilization element 46a and the transmission element 58a engage in one another, in particular at least in sections, in the operating state.

In the operating state the stabilization element 46a in particular stabilizes the retaining element 18a on the movement path 22a. In particular the stabilization element 46a is provided to stabilize the retaining element 18a on the movement path 22a. In the operating state the stabilization element 46a in particular prevents the occurrence of significant mechanical friction, allowing in particular problem-free drive and/or drive with little energy expenditure.

The cooking vessel device 10a comprises in particular at least one and advantageously just one housing unit 28a (see FIGS. 2 to 9). The housing unit 28a is provided in particular for positioning on the cooking vessel 12a. In the operating state the housing unit 28a is positioned in particular on the cooking vessel 12a.

For example the housing unit 28a could be configured as a single piece. The housing unit 28a could be configured for example in multiple parts. In particular the housing unit 28a comprises at least one and advantageously just one housing base element 62a. The housing base unit 62a is provided in particular for positioning on the cooking vessel 12a. In the operating state the housing base element 62a is arranged in particular in contact with the cooking vessel 12a, in particular at least in sections. In particular the housing base element 62 forms a partial region of the housing unit 28a facing the cooking vessel 12a in the operating state.

The housing unit 28a comprises in particular at least one and advantageously just one housing element 64a. The housing element 64 is provided in particular for coupling to the housing base element 62a. In the operating state the housing base element 62a and the housing element 64a are in particular coupled to one another, in particular at least in sections, and are arranged in particular so that they are in contact with one another, in particular at least in sections. In particular in the operating state the housing element 64a forms a partial region of the housing unit 28a facing away from the cooking vessel 12a.

The housing unit 28a comprises in particular at least one and advantageously just one bearing surface 30a and in particular forms the bearing surface 30a. In particular the housing element 64a forms the bearing surface 30a. The bearing surface 30a is configured in particular as a partial surface region of the housing unit 28a and advantageously of the housing element 64a. In particular the bearing surface 30a is provided to hold at least one cooking vessel lid 32a (see FIG. 2).

The cooking vessel device 10a comprises in particular at least one and advantageously just one, in particular at least the and advantageously just the, cooking vessel lid 32a. In the operating state the cooking vessel lid 32a in particular at least partially delimits the food receiving chamber 36a. In the operating state the bearing surface 30a and the cooking vessel lid 32a are arranged in particular in contact with one another, in particular at least in sections.

The housing unit 28a encloses at least one and advantageously just one fill opening 34a at least largely and advantageously completely, in particular by means of the housing base element 62a and/or by means of the housing element 64a, in particular in at least one plane. The fill opening 34a is provided in particular for the insertion of food into the food receiving chamber 36a. In the operating state an operator can insert and/or introduce food into the food receiving chamber 36a in particular through the fill opening 34a.

In particular the fill opening 34a has an opening diameter 38a. The opening diameter 38a of the fill opening 34a corresponds in particular at least substantially to the cooking vessel diameter 26a of the cooking vessel 12a.

The cooking vessel device 10a comprises in particular at least one and advantageously just one energy storage unit 40a (see FIG. 5). The energy storage unit 40a is provided in particular to store energy, in particular electrical energy. In particular the energy storage unit 40a is provided to supply energy to the drive unit 20a. In the operating state the energy storage unit 40a in particular supplies the drive unit 20a with energy.

The cooking vessel device 10a comprises in particular at least one and advantageously just one handle 42a (see FIG. 5). The handle 42a is provided in particular for in particular releasable coupling, advantageously coupling in such a manner that it can be released without tools, to the housing unit 28a. In the operating state the handle 42a is attached in particular to the housing unit 28a and/or coupled to the housing unit 28a in particular releasably, advantageously in such a manner that it can be released without tools.

The housing unit 28a in comprises in particular at least one and advantageously just one coupling interface 66a (see FIGS. 2, 6, 7), which is provided in particular for coupling to the handle 42a. The handle 42a comprises in particular at least one and advantageously just one handle coupling interface (not shown), which is provided in particular for coupling to the housing unit 28a, in particular to the coupling interface 66a of the housing unit 28a.

The handle 42a defines and/or delimits in particular at least one and advantageously just one receiving chamber 68a (see FIG. 5). The handle 42a, in particular the receiving chamber 68a of the handle 42a, is provided in particular to receive at least one structural unit.

In the operating state the drive unit 20a is integrated at least partially in the handle 42a, in particular the receiving chamber 68a of the handle 42a. In the operating state in particular at least the drive motor 60a of the drive unit 20a is at least largely integrated in the handle 42a, in particular the receiving chamber 68a of the handle 42a.

In the operating state the energy storage unit 40a in particular is at least largely integrated in the handle 42a, in particular the receiving chamber 68a of the handle 42a.

The cooking vessel device 10a comprises in particular at least one and advantageously just one electronics unit 70a (see FIG. 5). In particular the electronics unit 70a is configured as a control unit and/or regulation unit. In the operating state the electronics unit 70a controls and/or regulates in particular at least the drive unit 20a and/or the stirring unit 14a and/or the energy storage unit 40a. In particular in the operating state the electronics unit 70a is arranged at least largely and advantageously completely in the handle 42a.

In particular the cooking vessel device 10, in particular the housing unit 28a and/or the handle 42a and/or the stirring unit 14a and/or the drive unit 20a and/or the energy storage unit 40a is coupled releasably, in particular in such a manner that it can be released without tools, to the cooking vessel 12a in the operating state. In the operating state the housing unit 28a is configured in particular in an at least substantially water-tight manner and in particular prevents at least any penetration of liquid, in particular water, into at least one internal space of the housing unit 28a, in which in particular the drive unit 20a is at least partially integrated and/or arranged.

In particular the cooking vessel device 10a is configured as dishwasher-safe. In particular at least the drive unit 20a, in particular the drive motor 60a of the drive unit 20a, and/or the energy storage unit 40a and/or the stirring unit 14a, in particular the stirring element 16a and/or the retaining element 18a, are arranged on the cooking vessel 12a releasably, in particular in such a manner that they can be released without tools. The stirring element 16a is configured in particular as dishwasher-safe and can in particular be cleaned at least by a dishwasher, due to its releasable arrangement on the cooking vessel 12a.

FIGS. 11 to 14 show a further exemplary embodiment of the invention. The descriptions that follow are limited substantially to the differences between the exemplary embodiments, it being possible to refer to the description of the exemplary embodiment in FIGS. 1 to 10 for parts, features and functions that remain the same. To distinguish between the exemplary embodiments the letter a in the reference characters of the exemplary embodiment in FIGS. 1 to 10 is replaced by the letter b in the reference characters of the exemplary embodiment in FIGS. 11 to 14. Reference can also be made in principle to the drawings and/or the description of the exemplary embodiment in FIGS. 1 to 10 for parts designated in the same manner, in particular for parts with the same reference characters.

FIG. 11 in particular shows a detail of a housing unit 28b and a drive unit 20b of an alternative cooking vessel device 10b of an alternative cooking system 48b. The housing unit 28b comprises in particular a housing base element 62b and in particular a housing element 64b, which are in particular connected to one another and advantageously fastened to one another in a mounted state. FIG. 11 shows the housing base element 62b and the housing element 64b in particular in an unmounted state.

In the mounted state the housing unit 28b, in particular the housing base element 62b and the housing element 64b, defines and/or delimits at least one and advantageously just one hollow space 72b, within which the drive unit 20b is in particular at least partially integrated in the mounted state (see FIGS. 12 and 13). In particular a transmission element 58b of the drive unit 20b is integrated in the hollow space 72b in the mounted state. The transmission element 58b is connected in particular in a rotationally fixed manner to at least one retaining element 18b of a stirring unit 14b. In particular the transmission element 58b transmits a drive torque to the retaining element 18b in the operating state, with the result that the drive unit 20b moves the retaining element 18b in particular along a movement path 22b. Such movement of the retaining element 18b along the movement path 22b takes place in particular as set out in the exemplary embodiment in FIGS. 1 to 10, so reference is made in particular to said details here.

The drive unit 20b in particular comprises at least one stabilization element 46b, in particular to stabilize the retaining element 18b on the movement path 22b (see FIGS. 12 and 13). In the present exemplary embodiment the drive unit 20b in particular comprises sixteen stabilization elements 46b. Alternatively the drive unit 20b could in particular comprise a different number of stabilization elements 46b. For example the drive unit 20b could comprise a larger number of stabilization elements 46b, for example at least twenty, in particular at least thirty, advantageously at least forty and preferably at least fifty. Alternatively the drive unit 20b could in particular comprise a smaller number of stabilization elements 46b, for example at least four, in particular at least six, advantageously at least eight, particularly advantageously at least ten and preferably at least twelve. Only one of the stabilization elements 46b is described in the following.

The stabilization element 46b is provided in particular to stabilize the retaining element 18b on the movement path 22b. In the operating state the stabilization element 46b stabilizes the retaining element 18b in particular on the movement path 22b.

The stabilization element 46b is in particular part of at least one roller bearing 74b (see FIGS. 11 to 13). The cooking vessel device 10b comprises in particular at least one roller bearing 74b. In the present exemplary embodiment the cooking vessel device 10b comprises in particular at least two and advantageously just two roller bearings 74b.

One roller bearing 74b1 of the roller bearings 74b is arranged in particular on the housing unit 28b, in particular on the housing base element 62b of the housing unit 28b, being designated in the following in particular as the roller bearing 74b1 arranged on the housing unit 28b.

One roller bearing 74b2 of the roller bearings 74b is arranged in particular on the drive unit 20b, in particular on the transmission element 58b of the drive unit 20b, being designated in the following in particular as the roller bearing 74b2 arranged on the drive unit 20b.

The cooking vessel device 10b comprises at least one bearing element 76b, in particular per stabilization element 46b (see FIGS. 11 to 13). In the present exemplary embodiment the cooking vessel device 10b in particular comprises sixteen bearing elements 76b. A number of bearing elements 76b in particular corresponds to a number of stabilization elements 46b.

In the present exemplary embodiment in particular eight bearing elements 76b1 of the bearing elements 76b are arranged on the housing base element 62b and are in particular part of the roller bearing 74b1 arranged on the housing unit 28b. In particular the bearing elements 76b1 arranged in particular on the housing unit 28b are evenly distributed in a circumferential direction on the housing base element 62b. Only one of the bearing elements 76b1 arranged on the housing base element 62b in particular is described in the following.

In particular the bearing element 76b1 arranged in particular on the housing base element 62bis part of the housing unit 28b. The bearing element 76b1 arranged in particular on the housing base element 62b is configured in particular as a single piece with the housing base element 62b. The bearing element 76b1 arranged in particular on the housing base element 62b defines and/or delimits in particular at least one receiving region 78b1. In particular at least one stabilization element 46b1 is arranged on the housing unit 28b and supported in particular at least in sections in the receiving region 78b1 of the housing unit 28b in the operating state. The receiving region 78b1 arranged in particular on the housing base element 62b is provided in particular to receive at least sections of the stabilization element 46b1 arranged in particular on the housing unit 28b. In particular at least sections of the stabilization element 46b1 arranged in particular on the housing unit 28b are supported in the receiving region 78b1 arranged in particular on the housing base element 62b. The receiving region 78b1 arranged in particular on the housing base element 62b is configured in particular as a well-like recess. The bearing element 76b1 arranged in particular on the housing base element 62b is configured in particular as a projection on the housing base element 62b.

The drive unit 20b comprises in particular at least one and advantageously just one guide path 80b. In the operating state at least sections of the stabilization element 46b1 arranged in particular on the housing unit 28b engage in the guide path 80b of the drive unit 20b. The guide path 80b of the drive unit 20b is formed in particular by the transmission element 58b. In particular the transmission element 58b defines the guide path 80b of the drive unit 20b at least in sections, in particular at least largely and advantageously completely. In the operating state the guide path 80b of the drive unit 20b is arranged in particular on a side of the transmission element 58b facing the housing base element 62b. The guide path 80b of the drive unit 20b is configured in particular as a well-like recess of the transmission element 58b.

In the present exemplary embodiment eight bearing elements 76b2 of the bearing elements 76b are arranged in particular on the transmission element 58b and are in particular part of the roller bearing 74b2 arranged on the drive unit 20b. In particular the bearing elements 76b2 arranged in particular on the drive unit 20b are evenly distributed in a circumferential direction on the transmission element 58b. Only one of the bearing elements 76b2 arranged on the transmission element 58b in particular is described in the following.

In particular the bearing element 76b2 arranged in particular on the transmission element 58b is part of the drive unit 20b. The bearing element 76b2 arranged in particular on the transmission element 58b is in particular configured as a single piece with the transmission element 58b. The bearing element 76b2 arranged in particular on the transmission element 58b defines and/or delimits in particular at least one receiving region 78b2.

In particular in the operating state at least one stabilization element 46b2 is arranged on the drive unit 20b and supported at least in sections in the receiving region 78b2 of the drive unit 20b. The receiving region 78b2 arranged in particular on the transmission element 58b is provided in particular to receive at least sections of the stabilization element 46b arranged in particular on the drive unit 20b. In particular at least sections of the stabilization element 46b2 arranged in particular on the drive unit 20b are supported in the receiving region 78b2 arranged in particular on the transmission element 58b in the operating state. The receiving region 78b2 arranged in particular on the transmission element 58b is configured in particular as a well-like recess. The bearing element 76b2 arranged in particular on the transmission element 58b is configured in particular as a recess of the transmission element 58b.

The housing unit 28b comprises in particular at least one and advantageously just one guide path 82b. In the operating state at least sections of the stabilization element 46b2 arranged in particular on the drive unit 20b engage in the guide path 82b of the housing unit 28b. The guide path 82b of the housing unit 28b is formed in particular by the housing element 64b. In particular the housing element 64b defines the guide path 82b of the housing unit 28b at least in sections, in particular at least largely and advantageously completely. In the operating state the guide path 82b of the housing unit 28b is arranged in particular on a side of the housing element 64b facing the transmission element 58b. The guide path 82b of the housing unit 28b is configured in particular as a well-like recess of the housing element 64b.

In the present exemplary embodiment the housing unit 28b, in particular the housing base element 62b, comprises in particular at least one and advantageously just one drive recess 84b (see FIG. 11). In the operating state in particular at least one drive motor 60b of the drive unit 20b transmits a drive force and/or drive torque to the transmission element 58b through the drive recess 84b.

### REFERENCE CHARACTERS

10 Cooking vessel device
12 Cooking vessel
14 Stirring unit
16 Stirring element
18 Retaining element
20 Drive unit
22 Movement path
24 Diameter
26 Cooking vessel diameter
28 Housing unit
30 Bearing surface
32 Cooking vessel lid
34 Fill opening
36 Food receiving chamber
38 Opening diameter
40 Energy storage unit
42 Handle
44 Drive element
46 Stabilization element
48 Cooking system
50 Cooking appliance
52 Appliance plate
54 Appliance operator interface
56 Appliance control unit
58 Transmission element
60 Drive motor
62 Housing base element
64 Housing element
66 Coupling interface
68 Receiving chamber
70 Electronics unit
72 Hollow space
74 Roller bearing
76 Bearing element
78 Receiving region
80 Guide path
82 Guide path
84 Drive recess

1-18. (canceled)

19. A cooking vessel device for a cooking vessel, said cooking vessel device comprising:
a stiffing unit comprising a stiffing element and a retaining element, which retains the stiffing element in an operating state; and
a drive unit configured to move the retaining element along a movement path in the operating state.

20. The cooking vessel device of claim 19, wherein the movement path has a length of at least 5 cm.

21. The cooking vessel device of claim 19, wherein the movement path has a diameter of at least 3 cm.

22. The cooking vessel device of claim 21, wherein the diameter corresponds at least substantially to a cooking vessel diameter of the cooking vessel.

23. The cooking vessel device of claim 19, wherein the movement path is circular.

24. The cooking vessel device of claim 19, further comprising a housing unit provided for positioning on the cooking vessel.

25. The cooking vessel device of claim 24, wherein the housing unit comprises a bearing surface to hold a cooking vessel lid.

26. The cooking vessel device of claim 24, wherein the housing unit at least largely encloses in at least one plane a fill opening provided for inserting food into a food receiving chamber of the cooking vessel.

27. The cooking vessel device of claim 26, wherein the fill opening of the housing unit has an opening diameter, which corresponds at least substantially to a cooking vessel diameter of the cooking vessel.

28. The cooking vessel device of claim 19, further comprising an energy storage unit, which supplies the drive unit with energy in the operating state.

29. The cooking vessel device of claim 19, further comprising a handle, said drive unit being at least partially integrated in the handle.

30. The cooking vessel device of claim 19, wherein the drive unit comprises a gear drive.

31. The cooking vessel device of claim 19, wherein the drive unit comprises a stabilization element, which is provided to stabilize the retaining element on the movement path.

32. The cooking vessel device of claim 31, wherein the stabilization element is part of a roller bearing.

33. The cooking vessel device of claim 24, wherein the drive unit comprises a stabilization element, which is provided to stabilize the retaining element on the movement path, said stabilization element having at least one section supported in a receiving region of the housing unit.

34. The cooking vessel device of claim 31, wherein the stabilization element has at least one section supported in a receiving region of the drive unit.

35. The cooking vessel device of claim 19, wherein the stiffing element is configured as a wall-based stiffing element.

36. A cooking system, comprising:
a cooking vessel; and
a cooking vessel device for the cooking vessel, said cooking vessel device comprising a stiffing unit comprising a stirring element and a retaining element, which retains the stiffing element in an operating state; and a drive unit configured to move the retaining element along a movement path in the operating state.

37. The cooking system of claim 36, wherein the movement path has a diameter, which corresponds at least substantially to a cooking vessel diameter of the cooking vessel.

38. The cooking system of claim 36, wherein the cooking vessel device includes a housing unit provided for positioning on the cooking vessel.

39. The cooking system of claim 38, further comprising a cooking vessel lid, said housing unit comprising a bearing surface to hold the cooking vessel lid.

40. The cooking system of claim 38, wherein the housing unit at least largely encloses in at least one plane a fill opening provided for inserting food into a food receiving chamber of the cooking vessel.
